(19) United States
(12) Patent Application Publication
(10) Pub. No.: US 2026/0124619 A1
(43) Pub. Date: May 7, 2026

(54) DEVICE FOR COLLECTING BIOLOGICAL SAMPLES

(71) Applicants: SOCIÉTÉ BIC, Clichy (FR); BIC Violex Single Member S.A., Anoixi (GR)

(72) Inventors: Georgios KATSIKAS, Anoixi (GR); Panagiotis KOPELAS, Anoixi (GR); Efthymios SALTAS, Anoixi (GR); Phaedon PAPAGEORGIS PAPADOPOULOS, Anoixi (GR); Etienne MICHENAUD, Clichy (FR)

(73) Assignees: SOCIÉTÉ BIC, Clichy (FR); BIC Violex Single Member S.A., Anoixi (GR)

(21) Appl. No.: 18/704,636

(22) PCT Filed: Oct. 26, 2022
(86) PCT No.: PCT/EP2022/079946

§ 371 Date: Apr. 25, 2024

(30) Foreign Application Priority Data
Oct. 27, 2021 (EP) 21306497.5

(51) Int. Cl. B01L 3/00

(52) U.S. Cl. CPC B01L 3/5029; B01L 3/523; B01L 2200/025; B01L 2200/16; B01L 2300/025; B01L 2300/047; B01L 2300/049; B01L 2300/0609; B01L 2300/0672; B01L 2300/069; B01L 2400/0406; B01L 2400/06

(57) ABSTRACT

The present disclosure relates to a device for collecting one or more biological samples comprising a housing and a collector element. The collector element is configured to allow the passage of liquid and extends between a first end and a second end. The first end of the collector element protrudes out of the housing for collecting the one or more biological samples, and the second end of the collector element is arranged within the housing. The device further comprises at least one anchor element which extends at least partially into the collector element for maintaining the position of the collector element with respect to the housing.

This application claims benefit from European patent application EP 21306497.5, filed on 27 Oct. 2021, its content being incorporated herein by reference.

### BACKGROUND OF THE PRESENT DISCLOSURE

The present disclosure relates to device for collecting one or more biological samples, which may be subsequently used for molecular biology processing techniques such as nucleic acid amplification and/or detection.

Polymerase Chain Reaction (PCR) is a known method of amplifying nucleic acids, employed to test for the presence of specific nucleic acids (DNA or RNA) in a biological sample. It is used among other purposes as a diagnostic method to identify markers for pathogens or diseases. Other methods of amplifying nucleic acid samples include isothermal amplification methods such as Recombinase Polymerase Amplification (RPA) and Loop-Mediated Isothermal Amplification (LAMP).

Devices for collecting one or more biological samples-in particular for collecting saliva from the mouth of the consumer—are known from WO 2020/191232 A1, WO 2020/106345 A1, WO 2020/238035 A1 and EP 3 028 030 A1. Those devices comprise a wick as collector element. However, the wick is very soft and is difficult to maintain and fasten into the housing of the device.

The object of the present disclosure is to provide a device for collecting one or more biological samples having a collector element which can be mounted more easily on the device. In addition, the collector element should be securely mounted and maintained within the housing of the device to avoid an undesired removal.

### SUMMARY OF THE PRESENT DISCLOSURE

The present disclosure is directed to a device for collecting one or more biological samples as defined in independent claim 1. The dependent claims depict embodiments of the present disclosure.

According to the present disclosure, a device for collecting one or more biological samples is provided which comprises a housing and a collector element, wherein the collector element is configured to allow the passage of liquid. The collector element has two ends, the first end of the collector element protruding out of the housing for collecting the one or more biological samples, the second end of the collector element being arranged within the housing. At least one anchor element extends at least partially into the collector element for maintaining the position of the collector element with respect to the housing.

It should be noted that the housing may consist of several separate housing parts. While one anchor element can be used, in some circumstances two, three or four anchor elements may be provided. Other number of anchor elements may also be provided. The collector element has a certain softness so that the at least one anchor element can extend at least partially into the collector element when the second end of the collector element is mounted within the housing. The softness of the collector element may be such that, when mounted, an anchor element extends at least 0.3 mm into the collector element, more specifically at least 0.5 mm, most specifically at least 0.8 mm, all compared to the undeformed state of the collector element. Alternatively or in addition, the softness of the collector element may be such that the anchor element extends at least 0.3 mm into the collector element (again compared to the undeformed state of the collector element), specifically at least 0.5 mm, most specifically at least 0.8 mm, when the force applied by an anchor element on the collector element in a position which corresponds to their mounted state is 1 Newton. In addition or alternatively, the density of the collector element may be between 0.1 to 0.25 g/cm³.

The collector element may generally have an elongated shape extending from the first end to the second end of the collector element. In the following disclosure, the axis of the collector element is defined as being the central gravitational axis extending from the first end to the second end. The cross-sectional shape of the collector element (in a plane which is perpendicular to the axis of the collector element) may at least partially be circular, oval or rectangular, in examples with rounded corners. The section of the collector element at its first end may have a conical section. In addition or alternatively, the first end of the collector element may be pointed.

The purpose of the collector element is to collect and/or absorb one or more biological samples. In case of dry biological samples, the biological samples may stick on the outer surface of the first end of the collector element. In case of biological samples which are contained in a liquid, the biological samples may be absorbed within the collector element. Therefore, the collector element should allow the passage of liquid at least partially in order to absorb a greater amount of the biological sample(s). The material of the collector element may be porous or may have an internal channel structure, and has, in examples, hydrophilic properties in order to absorb a large amount of liquid biological samples more quickly.

Suitable materials for the collector element include cotton-based materials, or a plastic based matrix such as PE (polyethylene), PP (polypropylene) or PVDF (polyvinylidene fluoride) or a combination thereof, which can be manufactured in a range of densities to retain biological samples of different viscosities. In examples, the collector element may be made of a combination of PE and PP. The PP may be the core portion and the PE may be the outer coating, due to its particular properties on absorption of liquid via its capillary structure, and adsorption which is minimal with regards to nucleic acids. The collector element may comprise fibers, e.g. pressed fibers, made of one or more of these materials. The material of the collector element may be porous or may have an internal channel structure, and has preferably hydrophilic properties in order to absorb a large amount of liquid biological samples more quickly. The porosity may be at least 50%, more specifically at least 70%, most specifically at least 80%.

In addition, as will be explained below in more detail, the collector element may allow the passage of liquid from a container, in particular a buffer solution and/or a reagent solution, through the collector element towards its first end in order to drain the biological sample(s) out of the collector element. In particular, the collector element may allow the passage of liquid from its second end to its first end, or from the outer surface near the second end to the first end.

According to one embodiment, the housing of the device may have an anchor element in form of at least one flexible arm with at least one protrusion. The flexible arm is designed to be moved or flexed such that the protrusion can extend at least partially into the collector element. In examples, two, three, four or more flexible arms are provided. The housing may comprise a connector element which can be mounted on the main body of the housing on the side of the collector element. The connector element may have a first open end and a second open end such that the collector element can protrude out of the connector element through the first open end, and such that the at least one flexible arm can be guided into and through the second open end. The connector element may have an internal shape such that the at least one flexible arm is moved inwardly, i.e. towards the axis of the collector element, such that its protrusion extends into the collector element, when the at least one flexible arm is guided into the second open end of the connector element during mounting of the connector element on the main body of the housing.

Therefore, in the mounted state, the connector element exerts a radial force on the one or more flexible arms to maintain the protrusion within the collector element in order to achieve a locked state of the collector element. On the other hand, when the connector element is not yet mounted, the one or more flexible arms may have an unbiased position such that the diameter or position of the radially internal ends of the protrusions is equal or larger than the outer diameter or outer surface of the collector element in its undeformed state. With that, the second end of the collector element can easily be inserted into the housing. In this case, the locking of the collector element is achieved by mounting the connector element on the main body of the housing.

In examples, the housing of the device may have a hollow extension for holding the second end of the collector element. The hollow extension for holding second end of the collector element may have at least partially an internal shape and/or diameter which corresponds to the outer shape and/or diameter of the collector element at its second end. The hollow extension serves to hold the collector element in position before it has been anchored by the at least one anchor element and/or before the connector element has been mounted. In addition, the hollow extension provides more stability to the collector element after anchoring of the at least one anchor element and/or after mounting of the connector element.

The hollow extension may extend up to or beyond the at least one protrusion of the at least one flexible arm in direction towards the first end of the collector element. If the hollow extension extends beyond the at least one protrusion of the at least one anchor element, the hollow extension may have one or more recesses at the one or more protrusions such that the one or more protrusions can extend into the collector element. This feature provides increased mounting stability of the collector element within the device.

Alternatively or in addition, the hollow extension may have at least one recess which extends along the at least one flexible arm such that the flexible arm is arranged within the recess. With that, the anchor elements have more space for movement from an unbiased position to a biased position. The connector element may also at least partially have a hollow shape which comes into contact with the outer surface of the hollow extension and with the outer surface of the at least one flexible arm. This feature also provides increased mounting stability of the collector element within the device. The connector element and/or the outer surfaces of the anchor elements may also have a conical portion so that the connector element can be slided over the anchor elements more easily during mounting.

According to another embodiment of the present disclosure, the housing may comprise a connector element which is integrally formed on the housing, or which is formed as a separate element which can be mounted on the main body of the housing. The connector element may have a hollow space for holding the collector element such that the collector element can protrude out of the connector element. The at least one anchor element may have the shape of a hook which is arranged within the hollow space of the connector element. The hook(s) may be integrally formed on the connector element. Therefore, the connector element including the anchor element(s) can be manufactured via an injection moulding method.

In all embodiments of the present disclosure, the each protrusion may have the shape of a hook with an angle of the front surface ranging between 10 to 75 degrees with respect to the longitudinal axis of the collector element. With this feature, the at least one flexible arm may be pushed outwardly and/or the collector element can be inserted more easily while its sections which come into contact with the hook(s) are slightly deformed.

In addition or alternatively, the at least one protrusion may have the shape of a hook with an angle of the rear surface ranging between 20 to 90 degrees with respect to the longitudinal axis of the collector element such that the rear surface of the protrusion blocks a removal of the collector element out of the housing.

According to another embodiment of the present disclosure, the housing may comprise a separate fixation element which can be mounted to or into the main body of the housing on the side of the collector element. The fixation element may have a hollow space for holding the collector element such that the collector element can protrude out of the fixation element. The fixation element has two or more parts which can be moved relative to one another. The at least one anchor element may have the shape of a protrusion arranged within the hollow space of the fixation element which extends at least partially into the collector element for maintaining the position of the collector element with respect to the housing.

In examples, the two parts of the fixation element may be connected via at least one hinge element such that the collector element can embraced by placing the collector element into one part of the fixation element and by rotating the other part of the fixation element on the collector element. In examples, the two parts of the fixation element may be separate parts, wherein the collector element can be embraced by placing the collector element into one part of the fixation element and by arranging the other part of the fixation element on the collector element. The two parts of the fixation element may have protrusions and corresponding recesses on their sides which come into contact with each other such that the two parts have the correct and/or matched position with respect to each other when the collector element is embraced by the two parts.

The main body of the housing may have an opening into which the fixation element can be inserted. The fixation element can be connected to the main body by a locking feature. This locking feature may be a snap-fit feature, e.g. with a circumferential groove on side of the main body and a circumferential protrusion on side of the fixation element. Alternatively, a threading may be provided so that the fixation element can be screwed into the main body.

According to another embodiment of the present disclosure, the at least one anchor element comprises at least one arm with at least one protrusion which can extend at least partially into the collector element. The at least one flexible arm is connected to an arm holder, and wherein the housing comprises a connector element which can be mounted on the main body of the housing on the side of the collector element. The connector element may be designed to hold the arm holder on the main body of the housing and has a front portion with an internal shape for engaging the at least one arm of the arm holder such that the at least one protrusion remains its position in the collector element. With this feature, the flexible arms (and, if desired the connector element) can be attached to the collector element before this subassembly is mounted on the main body of the housing.

As already mentioned, the connector element may have a first open end such that the collector element can protrude out of the connector element through the first open end. The at least one arm may be flexible, and the connector element may have an internal shape such that the at least one flexible arm is moved or held inwardly such that its protrusion extends into the collector element during mounting of the connector element on the main body of the housing. The connector element may have a locking feature for maintaining the connector element on the main body of the housing (e.g. a snap-fit feature or a threading). For better positioning and stability, the main body of the housing may have a front end with a surface which corresponds at least partially to the shape of the arm holder.

According to another embodiment of the present disclosure, the housing comprises a connector element which can be mounted on the main body of the housing on the side of the collector element. The connector element comprises at least one flexible arm having at least one protrusion for extending at least partially into the collector element. Again, the connector element may have a first open end such that the collector element can protrude out of the connector element through the first open end. The at least one flexible arm may extend from the first open end into a hollow space of the connector element, i.e. towards the main body of the housing.

The housing may have a hollow extension for at least partially receiving the at least one flexible arm. The hollow extension has one or more first sections for engaging the at least one flexible arm such that the at least one protrusion remains position within the collector element. Said in other words, the one or more first sections maintain the flexible arm(s) in their locked state. In addition, the hollow extension has one or more second sections which are arranged at least partially between the flexible arms, and which are in contact with the collector element. This feature provides increased stability to the collector element in its mounted state.

According to another embodiment of the present disclosure, the housing may comprise a hollow extension for holding the collector element. The hollow extension has at least one radial hole, and the at least one anchor element extends through the at least one radial hole and at least partially into the collector element for maintaining the position of the collector element with respect to the housing. The housing may comprise a cover element which can be mounted on the front end of the housing. The cover element covers the at least one radial hole for securing the anchor element in its position, and the cover element has a first open end such that the collector element can protrude out of the cover element through the first open end. The at least one anchor element may be a pin extending between two holes of the hollow extension and through the collector element.

In all embodiments of the present disclosure, the following additional features may be provided.

As already mentioned, the collector element may be soft and/or flexible such that the anchor element can extend at least partially into the collector element. In addition, the device may comprise an abutment surface or a stop for limiting the movement of the collector element into the housing.

The device may further comprise a container for storing liquid, in particular a buffer solution and/or a reagent solution therein. In addition, the housing may comprise or enclose a channel for guiding the liquid stored in the container to the collector element. The device may further comprise a release mechanism for opening a passage from the container to the channel so that liquid stored in the container can enter the channel from the container and reach the collector element. This release mechanism may, for example, be a valve or a cover sheet on one side of the container which can be penetrated by a needle by moving the container further into the housing.

Therefore, liquid stored in the container can reach the collector element through the channel when the release mechanism is open. At least part of the liquid can pass through the collector element by gravity acting on the liquid when the container is in a position vertically above the collector element. In examples, the volume of the container can be reduced after the release mechanism has opened the fluid passage from the container, for example by a movable plunger or by providing the container with flexible walls such that the liquid can be squeezed out of the container into the channel.

When the liquid from the container passes through the collector element, the biological sample can at least partially be washed out of the collector element for testing/analysis purposes.

The device may further comprise a cap element which can be fitted on the housing on the side on which the collector element is arranged. An element for indicating and/or measuring a reaction between a reagent and the at least one biological sample may be arranged within or on the cap element, in particular an element indicating the pH value of the mixture of the liquid from the container and of the at least one biological sample. In addition or alternatively, the cap element may comprises a reagent or an element comprising a reagent which is released to the mixture of liquid from the container and of the at least one biological sample. With these features, the device can be used not only for collecting biological samples, but also to analyze/test the samples on site (i.e. without the need of sending the device to a laboratory).

And finally, the cap element may comprise a window which is arranged such that a user can at least partially see the element for indicating and/or measuring a reaction between the reagent and the at least one biological sample.

### SHORT DESCRIPTION OF THE FIGURES

FIG. 1 shows a device for collecting one or more biological samples according to an embodiment of the present disclosure;

FIGS. 2a to 2c show the anchoring of a collector element according to a first embodiment of the present disclosure;

FIGS. 3a to 3c show the anchoring of a collector element according to a second embodiment of the present disclosure;

FIGS. 4a to 4c show the anchoring of a collector element according to a third embodiment of the present disclosure;

FIGS. 5a to 5d show the anchoring of a collector element according to a fourth embodiment of the present disclosure;

FIGS. 6a to 6e show the anchoring of a collector element according to a fifth embodiment of the present disclosure;

FIGS. 7a and 7b show the anchoring of a collector element according to a sixth embodiment of the present disclosure;

FIGS. 8a and 8b show the anchoring of a collector element according to a seventh embodiment of the present disclosure;

FIGS. 9a to 9c show the anchoring of a collector element according to a eighth embodiment of the present disclosure;

FIG. 10 show the anchoring of a collector element according to a nineth embodiment of the present disclosure; and

FIG. 11 show a cross-sectional drawing of a device according to the present disclosure.

### DETAILED DESCRIPTION OF THE PRESENT DISCLOSURE

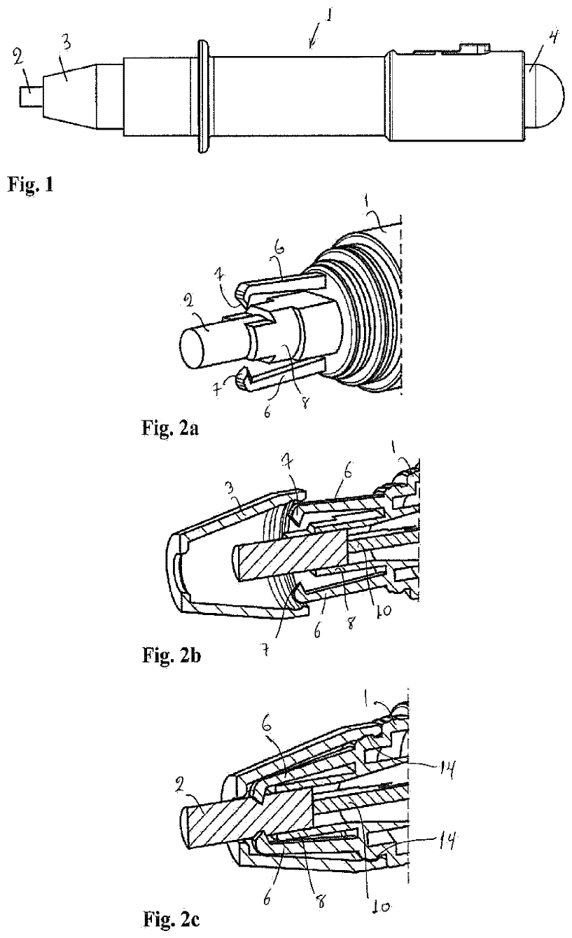

FIG. 1 shows a device for collecting one or more biological samples according to an embodiment of the present disclosure. The device comprises a housing 1 and a collector element 2. The collector element 2 allows the passage of liquid. As already mentioned, the housing may consist of several separate housing parts. The collector element 2 has two ends, the first end of the collector element protruding out of the housing 1 for collecting the one or more biological samples, the second end of the collector element 2 being arranged within the housing 1. The device may also comprise a container 4 for storing liquid, in particular a buffer solution and/or a reagent solution therein as will be explained in more detail in context with FIG. 11.

In all embodiments of the present disclosure, at least one anchor element 6 extends at least partially into the collector element 2 for maintaining the position of the collector element with respect to the housing 1. Regarding the softness range, the shape, the absorption properties and the material of the collector element 2, it is referred to the above summary section of the present disclosure.

FIGS. 2a to 2c show the anchoring of a collector element 2 according to a first embodiment of the present disclosure. The housing 1 of the device has an anchor element in form of two flexible arms 6 each having one protrusion 7. The flexible arms 6 are designed to be moved or flexed such that the protrusion 7 can extend at least partially into the collector element 2. The housing may comprise a connector element 3 which can be mounted on the main body of the housing 1 on the side of the collector element 2. The connector element 3 may have two open ends such that the collector element 2 can protrude out of the connector element 3 through a first open end, and such that the flexible arms can be guided into and through the second open end.

The connector element 3 may have an internal conical section such that the two flexible arms are moved inwardly, i.e. towards the axis of the collector element, such that their protrusions 7 extend into the collector element 2, when the two flexible arms are guided into the second open end of the connector element during mounting of the connector element on the main body of the housing 1 as shown in FIGS. 2b and 2c.

In the mounted state, the connector element 3 exerts a radial force on the two flexible arms to maintain the protrusions 7 within the collector element 2 in order to achieve a locked state of the collector element 2. On the other hand, when the connector element 3 is not yet mounted, the flexible arms 6 may have an unbiased position such that the diameter or position of the radially internal ends of the protrusions 7 is equal or larger than the outer diameter or outer surface of the collector element in its undeformed state. With that, the second end of the collector element 2 can easily be inserted into the housing. In this case, the locking of the collector element 3 is achieved by mounting the connector element 2 on the main body of the housing.

In examples, the flexible arms 6 may have an unbiased position which corresponds to the position as shown in FIG. 2c. In this case, the flexible arms 6 are flexed outwardly when the collector element 2 is inserted into the housing. The front surfaces of the protrusions 7 may be canted such that the second end of the collector element 2 pushes the flexible arms 6 outwardly during mounting.

In addition, the housing 1 of the device may have a hollow extension 8 for holding second end of the collector element 2. The hollow extension 8 for holding second end of the collector element may have at least partially an internal shape and/or diameter which corresponds to the outer shape and/or diameter of the collector element 2 at its second end. The diameter of the collector element may, for example, be in the range of 2.5 mm to 3.5 mm. The hollow extension serves to hold the collector element in position before it has been anchored by the at least one anchor element and/or before the connector element has been mounted. In addition, the hollow extension provides more stability to the collector element after anchoring of the at least one anchor element and/or after mounting of the connector element.

The hollow extension 8 may extend up to or beyond the at least one protrusion of the at least one flexible arm in direction towards the first end of the collector element 2. If the hollow extension 8 extends beyond the at least one protrusion 7 of the at least one anchor element, as shown in FIGS. 2a and 2b, the hollow extension 8 may have recesses 9 at the protrusions 7 such that the protrusions 7 can extend into the collector element 2. This feature provides increased mounting stability of the collector element 2 within the device as the hollow extension holds the second end of the collector element 2 and also holds the central part of the collector element 2 circumferentially neighboring to the flexible arms 6 and/or neighboring to the protrusions 7.

Typically, the second end of the collector element 2 is mounted on the housing first by introducing the second end into the hollow extension 8 as shown in FIG. 2a. The device may comprise an abutment surface or a stop 10 for limiting the movement of the collector element 2 into the housing. The connector element 3 is subsequently guided over the collector element 2 as shown in FIG. 2b, and finally secured to the housing via a locking feature 14. This locking feature 14 may be a snap-fit feature (e.g. with a circumferential groove on the internal side of the connector element 3 and a circumferential protrusion on side of the housing as shown in FIG. 2c) or a threading.

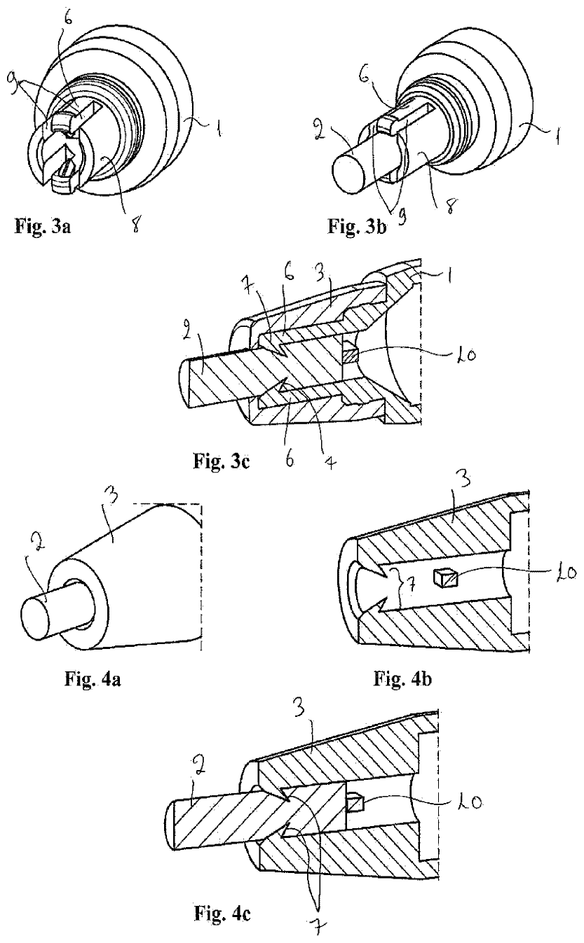

FIGS. 3a to 3c show the anchoring of a collector element according to a second embodiment of the present disclosure. The housing 1 of the device has an anchor element in form of two flexible arms 6 each having one protrusion 7. The flexible arms 6 are designed to be moved or flexed such that the protrusion 7 can extend at least partially into the collector element 2. A hollow extension 8 is provided which has two recesses 9 which extend along the two flexible arms such that the flexible arms 6 are arranged within the recesses 9. With that, the anchor elements have more space for movement from an unbiased position to a biased position.

The connector element 3 has a hollow shape which comes into contact with the outer surface of the hollow extension 8 and with the outer surface of the two flexible arms. This feature also provides increased mounting stability of the collector element within the device. In the shown embodiment, the inner surface of this hollow shape is cylindrical to enclose the cylindrical shape of the outer surface of the hollow extension 8. However, if the cross-sectional shape of the collector element is oval or rectangular, in examples with rounded corners, the outer surface of the hollow extension and the inner surface of the hollow space may also correspond to the cross-sectional shape of the collector element (i.e. oval or rectangular). In addition or alternatively, the connector element 3 and/or the outer surfaces of the anchor elements may also have a conical portion (not shown in FIGS. 3a to 3c) so that the connector element can be slided over the anchor elements more easily during mounting.

In the embodiment shown in FIGS. 3a to 3c, the flexible arms 6 may have an unbiased position which corresponds to the anchored state of the collector element 2. In order to facilitate the insertion of the collector element 2 into the hollow extension 8 and into the flexible arms 6, the protrusions 7 of the flexible arms 6 may have the shape of hooks with an angle of the front surface ranging between 10 to 75 degrees with respect to the longitudinal axis of the collector element. In addition or alternatively, the collector element 2 may have a conical portion at its second end.

FIGS. 4a to 4c show the anchoring of a collector element 2 according to a third embodiment of the present disclosure. In this embodiment, the housing comprises a connector element 3 which is integrally formed on the housing. In examples, the connector element 3 may be formed as a separate element which can be mounted on the main body of the housing. The connector element 3 has a hollow space for holding the collector element 2 such that the collector element 2 can protrude out of the connector element 3. The device has two anchor elements, each having the shape of a hook or protrusion 7 which is arranged within the hollow space of the connector element. As shown, the hooks may be integrally formed on the connector element. Therefore, the connector element 3 including the anchor elements can be manufactured by an injection moulding method.

The front surfaces of the hooks have an angle ranging between 10 to 75 degrees with respect to the longitudinal axis of the collector element 2 so that the second end of the collector element can pass through the hooks while being partially deformed. An abutment surface or a stop 10 may be provided for limiting the movement of the collector element 2 into the housing. In addition or alternatively, the rear surface of the hooks may have an angle ranging between 20 to 90 degrees with respect to the longitudinal axis of the collector element such that the rear surface of the protrusion blocks a removal of the collector element out of the housing.

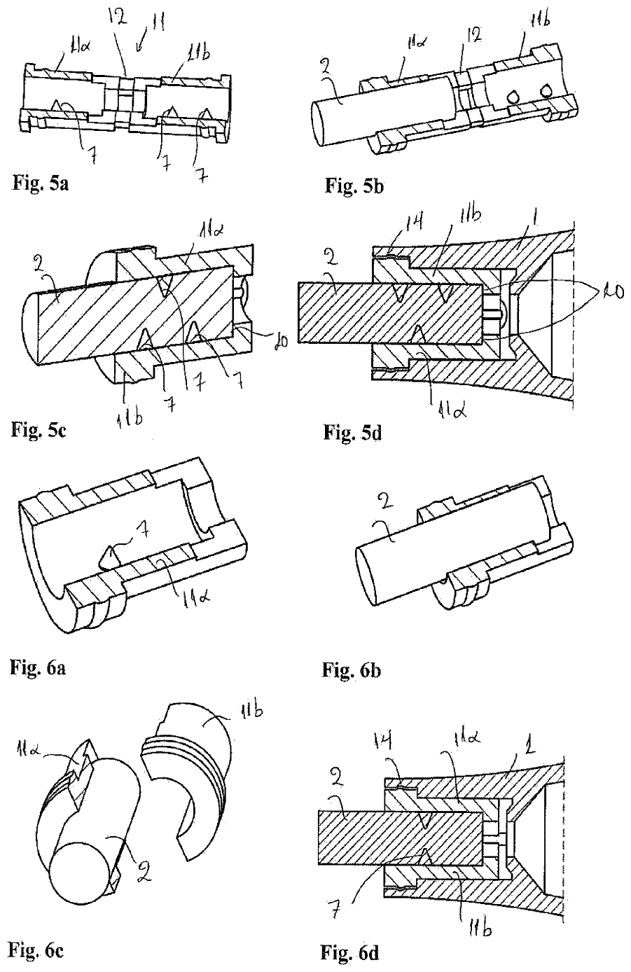

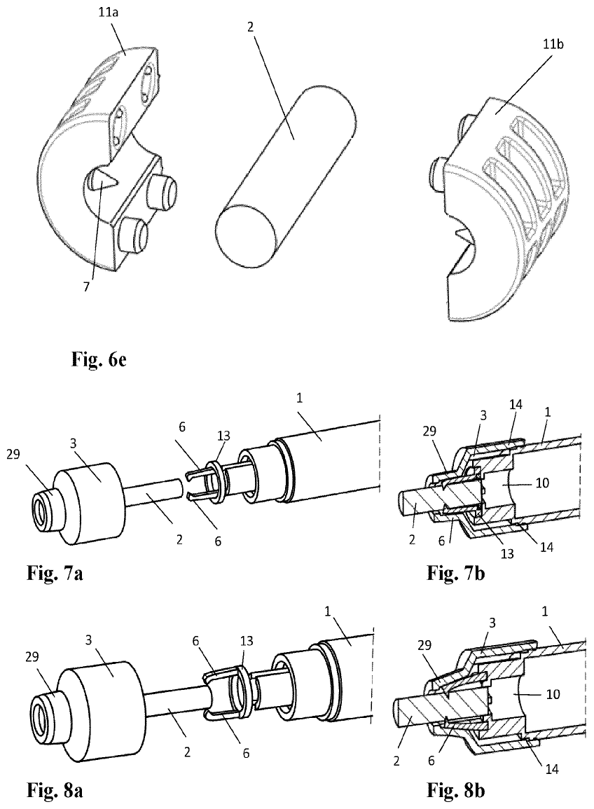

FIGS. 5a to 5d and FIGS. 6a to 6e show the anchoring of a collector element according to a fourth and fifth embodiment of the present disclosure. In these embodiments, the housing may comprise a separate fixation element 11 which can be mounted to or into the main body of the housing on the side of the collector element 2. The fixation element 11 has a hollow space for holding the collector element such that the collector element can protrude out of the fixation element 11. The fixation element has two parts 11a, 11b which can be moved relative to one another. The fixation element 11 of FIGS. 5a to 5d has three anchor elements, the fixation element 11 of FIGS. 6a to 6d has two anchor elements (one anchor element may be sufficient in some cases; more anchor elements may be provided). Each anchor element has the shape of a protrusion 7 arranged within the hollow space of the fixation element 11 which extends at least partially into the collector element for maintaining the position of the collector element 2 with respect to the housing.

The two parts 11a, 11b of the fixation element shown in FIGS. 5a to 5d may be connected by a hinge element 12 such that the collector element 2 can embraced by placing the collector element into one part of the fixation element (FIG. 5b) and by rotating the other part of the fixation element on the collector element (FIG. 5c). In examples, as shown in FIGS. 6a to 6e, the two parts 11a, 11b of the fixation element are separate parts, wherein the collector element can be embraced by placing the collector element into one part of the fixation element and by arranging the other part of the fixation element on the collector element. As shown in FIG. 6e, which is a variation of the fixation element of FIGS. 6a to 6d, the two parts of the fixation element may have protrusions and corresponding recesses on their sides which come into contact with each other (not shown in FIGS. 6a to 6d) such that the two parts have the correct and/or matched position with respect to each other when the collector element is embraced by the two parts. The protrusions and the corresponding recesses may be designed as snap-fit or press-fit fixations such that the two parts of the fixation element remain connected after the collector element has been mounted between those two parts.

In the embodiments shown in FIGS. 5a to 5d and FIGS. 6a to 6d, the main body of the housing may have an opening into which the fixation element 11 can be inserted. The fixation element can be connected to the main body by a locking feature 14. This locking feature 14 may be a snap-fit feature (e.g. with a circumferential groove on side of the main body and a circumferential protrusion on side of the fixation element). Alternatively, a threading may be provided so that the fixation element can be screwed into the main body.

FIGS. 7a and 7b and FIGS. 8a and 8b show the anchoring of a collector element according to a sixth and seventh embodiment of the present disclosure. In these embodiments, two flexible arms 6 are provided as anchor elements, each having one protrusion 7 which can extend at least partially into the collector element 2. The two flexible arms 6 are connected to an arm holder 13. The housing comprises a connector element 3 which can be mounted on the main body of the housing on the side of the collector element 2. The connector element 3 is be designed to hold the arm holder 13 on the main body of the housing and has a front portion 14 with an internal shape for engaging the two arms of the arm holder 13 such that the protrusions remain their position in the collector element 2. With this feature, the flexible arms 6 (and, in circumstances the connector element 3) can be attached to the collector element 2 before this subassembly is mounted on the main body of the housing.

As already mentioned, the connector element 3 may have a first open end such that the collector element 2 can protrude out of the connector element through the first open end. The connector element 3 may have an internal shape such that the two flexible arms 6 are moved or held inwardly such that their protrusions extend into the collector element 2 during mounting of the connector element on the main body of the housing. The connector element 3 may have a locking feature 14 for maintaining the connector element on the main body of the housing (e.g. a snap-fit feature or a threading). For better positioning and stability, the main body of the housing may have a front end with a surface which corresponds at least partially to the shape of the arm holder.

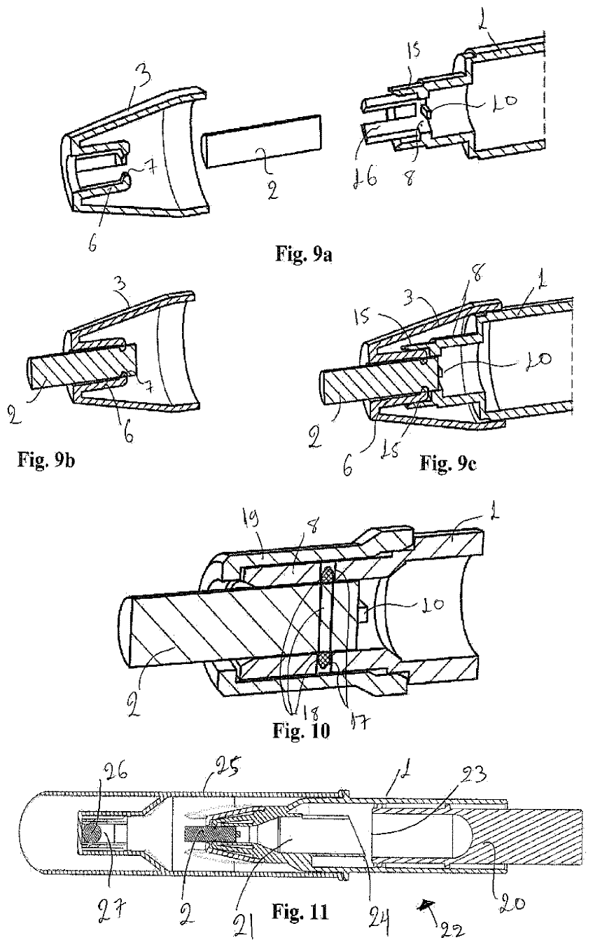

FIGS. 9a to 9c show the anchoring of a collector element according to a eighth embodiment of the present disclosure. In this embodiment, the housing comprises a connector element 3 which can be mounted on the main body of the housing on the side of the collector element 2. The connector element 3 comprises four flexible arms 6 each having a protrusion 7 for extending at least partially into the collector element 2. Again, the connector element 3 may have a first open end such that the collector element 2 can protrude out of the connector element 3 through the first open end. The two flexible arms 6 extend from the first open end into a hollow space of the connector element 3, i.e. towards the main body of the housing.

The housing may have a hollow extension 8 for at least partially receiving the two flexible arms 6. The hollow extension 8 has one or more first sections 15 for engaging the flexible arms 6 such that the protrusions remain position within the collector element 2. Said in other words, the one or more first sections 15 maintain the flexible arm(s) in their locked state. In addition, the hollow extension 8 has one or more second sections 16 which are arranged at least partially between the flexible arms, and which are in contact with the collector element 2. This feature provides increased stability to the collector element in its mounted state.

FIG. 10 show the anchoring of a collector element according to a nineth embodiment of the present disclosure. In this embodiment, the housing comprises a hollow extension 8 for holding the collector element 2. The hollow extension 8 has two radial holes/bores 17, and the anchor element, which may have the shape of a pin 18, extends through the radial hole/bores 17 and through the collector element 2 for maintaining the position of the collector element 2 with respect to the housing. The housing may comprise a cover element 19 which can be mounted on the front end of the housing. The cover element covers the radial holes/bores 17 for securing the anchor element in its position, and wherein the cover element 19 has a first open end such that the collector element 2 can protrude out of the cover element 19 through the first open end.

In all embodiments of the present disclosure, the device may comprise an abutment surface or a stop 10 for limiting the movement of the collector element 2 into the housing.

In all embodiments of the present disclosure, the collector element may have a softness as described above in the summary section such that the anchor element can extend at least partially into the collector element.

Suitable materials for the collector element include cotton-based materials, or specifically a plastic based matrix such as PE (polyethylene), PP (polypropylene) or PVDF (polyvinylidene fluoride) or a combination thereof, which can be manufactured in a range of densities to retain biological samples of different viscosities. The collector element may be made of a combination of PE and PP, wherein the PP is the core portion and the PE is the outer coating, due to its particular properties on absorption of liquid via its capillary structure, and adsorption which is minimal with regards to nucleic acids. The collector element may comprise fibers, e.g. preferably pressed fibers, made of one or more of these materials. The material of the collector element may be porous or may have an internal channel structure, and has, in examples, hydrophilic properties in order to absorb a large amount of liquid biological samples more quickly. The porosity should be at least 50%, more specifically at least 70%, most specifically at least 80%.

FIG. 11 show a cross-sectional drawing of a device according to the present disclosure in which the anchoring of the collector element 2 may be designed according to one of the embodiments described in this disclosure (FIG. 11 shows the anchoring of the first embodiment). The device may comprise a container 20 for storing liquid, in particular a buffer solution. In addition, the housing may comprise or enclose a channel 21 for guiding the liquid stored in the container 20 to the collector element 2. The device may further comprise a release mechanism 22 for opening a passage from the container 20 to the channel 21 so that liquid stored in the container can enter the channel 21 from the container 20 and reach the collector element 2. This release mechanism may, for example, be a valve or a cover sheet 23 on one side of the container which can be penetrated by a needle or by a penetrating device 24 by moving the container further into the housing.

Therefore, liquid stored in the container can reach the collector element 2 through the channel 21 when the release mechanism 22 is open, wherein at least part of the liquid can pass through the collector element 2 by gravity acting on the liquid when the container is in a position vertically above the collector element. In examples, the volume of the container 20 be designed to be reduced after the release mechanism has opened the fluid passage from the container, for example by a movable plunger or by providing the container 20 with flexible walls such that the liquid can be squeezed out of the container into the channel.

When the liquid from the container 20 passes through the collector element 2, the biological sample can at least partially be washed out of the collector element 2 for testing/analysis purposes.

The device may further comprise a cap element 25 which can be fitted on the housing on the side on which the collector element is arranged. The cap element may comprise a reagent 26 or an element comprising a reagent which is released to the mixture of liquid from the container and of the at least one biological sample. This element comprising a reagent may have the shape of a pellet. In addition, an element 27 for indicating and/or measuring a reaction between a reagent 26 and the at least one biological sample may be arranged in a reaction chamber of the cap element, in particular an element indicating the pH value of the mixture of the liquid from the container and of the at least one biological sample. With these features, the device can be used not only for collecting biological samples, but also to analyze/test the samples on site (i.e. without the need of sending the device to a laboratory).

The cap element 25 may comprise a window (not shown in the Figures) which is arranged such that a user can at least partially see the element for indicating and/or measuring a reaction between the reagent and the at least one biological sample. In examples, the cap element may be manufactured of a transparent material.

According to this disclosure, various amplification methods may be used, for example a recombinase polymerase amplification (RPA) which is a low temperature DNA and/or RNA amplification technique, or a ligase chain reaction (LCR).

The buffer liquid stored in the container 20 may contain purified water, milli-q water and buffer (e.g. TRIS-Cl/TE buffer), for example a Tris-HCl buffer. When LCR method is applied, buffer also contains PEG as crowding agent.

The reagents located in the cap may include a group of materials, such as primers, probes additionally to the enzymes, e.g. ligase or polymerase, and nucleotides. Generally, the reagents located in the cap are dependent on the used amplification method. A suitable reagent composition for RPA may contain enzymes (in particular enzymes for polymerase and/or enzymes for reverse transcriptase), proteins, primers, probes, oligonucleotides and reaction components necessary for the RPA reaction including reaction buffer, polyethylene glycol, pyrophosphatase, a regeneration system such as kinase/phosphocreatine system, or a mixture thereof. A suitable reagent composition for LCR may contain enzymes for DNA ligase and/or DNA probes.

Possible materials for the collector element have already been described. The collector element may additionally be treated. For example, reagents or active agents may be covalently bound to the collector element by chemical linkages through functionalisation (e.g.-OH groups), or they may be dried into the material of the collector element and become active on hydration with the sample. Alternatively or in addition, the collector element may be treated to provide ways of lysing virus, in particular a treatment to form a negatively charged surface, e.g. so as to retain the positively charged ions of the sample, or a treatment with anionic detergent. Possible active agents that render the collector element functionalized may lyse bacteria or viruses. These active agents may be quaternary ammonium compounds (QAC) and/or biocidal agents. Examples of these active agents are: Citral, Eucalyptus oil, Tea tree oil, Chlorhexidine, triterpenoid saponin, Polyphylla saponin I, Povidone-iodine, Cetyl pyridinium chloride (CPC), Benzalkonium chloride (BAC), Dequoalinium chloride.

Although the device of the present disclosure is defined in the following claims, it should be understood that the present disclosure can alternatively and/or in addition be defined according to the following embodiments:
1. A device for collecting one or more biological samples comprising a housing and a collector element,
   wherein the collector element allows the passage of liquid, and
   wherein the collector element has two ends,
      the first end of the collector element protruding out of the housing for collecting the one or more biological samples,
      the second end of the collector element being arranged within the housing, characterized by at least one anchor element which extends at least partially into the collector element for maintaining the position of the collector element with respect to the housing.
2. Device according to embodiment 1, wherein the housing has an anchor element in form of at least one flexible arm with at least one protrusion, wherein the flexible arm is designed to be moved or flexed such that the protrusion can extend at least partially into the collector element.
3. Device according to one of embodiments 1 or 2, wherein the housing comprises a connector element which can be mounted on the main body of the housing on the side of the collector element.
4. Device according to embodiment 3, wherein the connector element has two open ends such that the collector element can protrude out of the connector element through a first open end, and such that the at least one flexible arm can be guided into the second open end.
5. Device according to one of embodiments 3 or 4, wherein the connector element has an internal shape such that the at least one flexible arm is moved inwardly such that its protrusion extends into the collector element, when the at least one flexible arm is guided into the second open end of the connector element during mounting of the connector element on the main body of the housing.
6. Device according to one of the preceding embodiments, wherein the housing has a hollow extension for holding second end of the collector element.
7. Device according to embodiment 6, wherein the hollow extension for holding second end of the collector element has at least partially an internal shape and/or diameter which corresponds to the outer shape and/or diameter of the collector element.
8. Device according to one of embodiments 6 or 7, wherein the hollow extension extends up to or beyond the at least one protrusion of the at least one flexible arm in direction towards the first end of the collector element, and wherein the hollow extension has one or more recesses at the one or more protrusions such that the one or more protrusions can extend into the collector element.
9. Device according to one of embodiments 6 or 7, wherein the hollow extension has at least one recess which extends along the at least one flexible arm such that the flexible arm is arranged within the recess.
10. Device according to one of embodiments 3 or 4, wherein the connector element at least partially has a hollow shape which comes into contact with the outer surface of the hollow extension and with the outer surface of the at least one flexible arm.
11. Device according to embodiment 1, wherein the housing comprises a connector element which is integrally formed on the housing, or which is formed as a separate element which can be mounted on the main body of the housing, wherein the connector element has a hollow space for holding the collector element such that the collector element can protrude out of the connector element.
12. Device according to embodiment 1, wherein the at least one anchor element has the shape of a hook which is arranged within the hollow space of the connector element.
13. Device according to one of the preceding embodiments, wherein the at least one protrusion has the shape of a hook with an angle of the front surface ranging between 10 to 75 degrees with respect to the longitudinal axis of the collector element such that upon insertion of the collector element, the at least one flexible arm is pushed outwardly.
14. Device according to one of the preceding embodiments, wherein the at least one protrusion has the shape of a hook with an angle of the rear surface ranging between 20 to 90 degrees with respect to the longitudinal axis of the collector element such that the rear surface of the protrusion blocks a removal of the collector element out of the housing.
15. Device according to embodiment 1, wherein the housing comprises a fixation element which can be mounted to or into the main body of the housing on the side of the collector element, wherein the fixation element has a hollow space for holding the collector element such that the collector element can protrude out of the fixation element, and wherein the fixation element has two or more parts which can be moved relative to one another.
16. Device according to embodiment 15, wherein the at least one anchor element has the shape of a protrusion arranged within the hollow space of the fixation element which extends at least partially into the collector element for maintaining the position of the collector element with respect to the housing.
17. Device according to one of embodiments 15 or 16, wherein the two parts of the fixation element are connected by means of at least one hinge element such that the collector element can embraced by placing the collector element into one part of the fixation element and by rotating the other part of the fixation element on the collector element.
18. Device according to one of embodiments 15 or 16, wherein the two parts of the fixation element are separate parts, wherein the collector element can be embraced by placing the collector element into one part of the fixation element and by arranging the other part of the fixation element on the collector element.
19. Device according to one of embodiments 15 to 18, wherein the two parts of the fixation element have protrusions and corresponding recesses on their sides which come into contact with each other such that the two parts have the correct and/or matched position with respect to each other when the collector element is embraced by the two parts.
20. Device according to one of embodiments 15 to 19, wherein the main body of the housing has an opening into which the fixation element can be inserted, and wherein the fixation element can be connected to the main body by means of a locking feature.
21. Device according to embodiment 1, wherein the at least one anchor element comprises at least one arm with at least one protrusion which can extend at least partially into the collector element, wherein the at least one flexible arm is connected to an arm holder, wherein the housing comprises a connector element which can be mounted on the main body of the housing on the side of the collector element.
22. Device according to embodiment 21, wherein the connector element is designed to hold the arm holder on the main body of the housing and has a front portion with an internal shape for engaging the at least one arm of the arm holder such that the at least one protrusion remains its position in the collector element.
23. Device according to one of embodiments 21 or 22, wherein the connector element has a first open end such that the collector element can protrude out of the connector element through the first open end.
24. Device according to one of embodiments 21 to 23, wherein the at least one arm is flexible, and wherein the connector element has an internal shape such that the at least one flexible arm is moved inwardly such that its protrusion extends into the collector element during mounting of the connector element on the main body of the housing.
25. Device according to one of embodiments 21 to 24, wherein the connector element has a locking feature for maintaining the connector element on the main body of the housing.
26. Device according to one of embodiments 21 to 25, wherein the main body of the housing has a front end with a surface which corresponds at least partially to the shape of the arm holder.
27. Device according to embodiment 1, wherein the housing comprises a connector element which can be mounted on the main body of the housing on the side of the collector element, wherein the connector element comprises at least one flexible arm having at least one protrusion for extending at least partially into the collector element.
28. Device according to embodiment 27, wherein the connector element has a first open end such that the collector element can protrude out of the connector element through the first open end, and wherein the at least one flexible arm extends from the first open end into a hollow space of the connector element.
29. Device according to one of embodiments 27 or 28, wherein the housing has a hollow extension for at least partially receiving the at least one flexible arm, wherein the hollow extension has one or more first sections for engaging the at least one flexible arm such that the at least one protrusion remains position within the collector element.
30. Device according to one of embodiments 27 to 29, wherein the hollow extension has one or more second sections which are arranged at least partially between the flexible arms, and which are in contact with the collector element.
31. Device according to embodiment 1, wherein the housing comprises a hollow extension for holding the collector element, wherein the hollow extension has at least one radial hole, and wherein the at least one anchor element extends through the at least one radial hole and at least partially into the collector element for maintaining the position of the collector element with respect to the housing.
32. Device according to embodiment 31, wherein the housing comprises a cover element which can be mounted on the front end of the housing, wherein the cover element covers the at least one radial hole for securing the anchor element in its position, and wherein the cover element has a first open end such that the collector element can protrude out of the cover element through the first open end.
33. Device according to embodiment 31 or 32, wherein the at least one anchor element is a pin extending between two holes of the hollow extension and through the collector element.
34. Device according to one of the preceding embodiments, wherein the collector element is soft and/or flexible such that the anchor element can extend at least partially into the collector element.
35. Device according to one of the preceding embodiments, further comprising an abutment surface or a stop for limiting the movement of the collector element into the housing.
36. Device according to one of the preceding embodiments, further comprising a container for storing liquid, in particular a buffer solution and/or a reagent solution therein.
37. Device according to one of the preceding embodiments, wherein the housing comprises or encloses a channel for guiding the liquid stored in the container to the collector element.
38. Device according to one of the preceding embodiments, further comprising a valve and/or release mechanism for opening a passage from the container to the channel so that liquid stored in the container can enter the channel from the container and reach the collector element.
39. Device according to one of the preceding embodiments, wherein liquid stored in the container can reach the collector element through the channel when the valve and/or release mechanism is open, wherein at least part of the liquid can pass through the collector element by means of gravity acting on the liquid when the container is in a position vertically above the collector element.
40. Device according to one of the preceding embodiments, wherein the volume of the container can be reduced to squeeze liquid from the container into the channel.
41. Device according to one of the preceding embodiments, wherein the volume of the container can be reduced such that liquid is released from the container into the channel and passes through the collector element.
42. Device according to one of the preceding embodiments, further comprising a cap element which can be fitted on the housing on the side on which the collector element is arranged.
43. Device according to one of the preceding embodiments, characterized in that an element for indicating and/or measuring a reaction between a reagent and the at least one biological sample is arranged within or on the cap element, in particular an element indicating the pH value of the mixture of the liquid from the container and of the at least one biological sample.
44. Device according to one of the preceding embodiments, characterized in that the cap element comprises a reagent or an element comprising a reagent which is released to the mixture of liquid from the container and of the at least one biological sample.
45. Device according to one of the preceding embodiments, wherein the cap element comprises a window which is arranged such that a user can at least partially see the element for indicating and/or measuring a reaction between the reagent and the at least one biological sample.

1. A device for collecting one or more biological samples comprising a housing and a collector element.
wherein the collector element is configured to allow the passage of liquid, and
wherein the collector element extends between a first end and a second end,
the first end of the collector element protruding out of the housing for collecting the one or more biological samples,
the second end of the collector element being arranged within the housing,
wherein the device further comprises at least one anchor element which extends at least partially into the collector element for maintaining the position of the collector element with respect to the housing.

2. Device according to claim 1, wherein the at least one anchor element is in form of at least one flexible arm with at least one protrusion, wherein the flexible arm is designed to be moved or flexed such that the protrusion can extend at least partially into the collector element.

3. Device according to claim 2, wherein the housing comprises a connector element which is configured to be mounted on a main body of the housing on the side of the collector element.

4. Device according to claim 3, wherein the connector element has a first open end and a second open end such that the collector element can protrude out of the connector element through the first open end, and such that the at least one flexible arm can be guided into the second open end.

5. Device according to claim 3, wherein the housing comprises a hollow extension for holding the second end of the collector element, wherein the connector element at least partially has a hollow shape which comes into contact with the outer surface of the hollow extension and with the outer surface of the at least one flexible arm.

6. Device according to claim 1, wherein the housing comprises a connector element which is integrally formed on the housing, wherein the connector element has a hollow space for holding the collector element such that the collector element can protrude out of the connector element.

7. Device according to claim 1, wherein the housing comprises a fixation element which can be mounted to or into the main body of the housing on the side of the collector element wherein the fixation element has a hollow space for holding the collector element such that the collector element can protrude out of the fixation element.

8. Device according to claim 1, wherein the at least one anchor element comprises at least one flexible arm with at least one protrusion which can extend at least partially into the collector element wherein the at least one flexible arm is connected to an arm holder, wherein the housing comprises a connector element which can be mounted on the main body of the housing on the side of the collector element.

9. Device according to claim 1, wherein the housing comprises a connector element which can be mounted on the main body of the housing on the side of the collector element, wherein the connector element comprises at least one flexible arm having at least one protrusion for extending at least partially into the collector element.

10. Device according to claim 5, wherein the hollow extension has at least one radial hole and wherein the at least one anchor element extends through the at least one radial hole and at least partially into the collector element for maintaining the position of the collector element with respect to the housing.

11. Device according to claim 1, further comprising a container for storing liquid.

12-18. (canceled)

19. Device according to claim 11, wherein the liquid is a buffer solution and/or a reagent solution.

20. Device according to claim 11, wherein the housing comprises a channel for guiding the liquid stored in the container to the collector element, further comprising a valve and/or release mechanism for opening a passage from the container to the channel so that liquid stored in the container can enter the channel from the container and reach the collector element.

21. Device according to claim 11, wherein liquid stored in the container can reach the collector element through the channel when the valve and/or release mechanism is open, wherein at least part of the liquid can pass through the collector element by gravity acting on the liquid when the container is in a position vertically above the collector element.

22. Device according to claim 1, further comprising a cap element which can be fitted on the housing on the side on which the collector element is arranged.

23. Device according to claim 22, characterized in that the cap element comprises a reagent or an element comprising a reagent which is released to the mixture of liquid from the container and of the at least one biological sample.

24. Device according to claim 22, characterized in that an element for indicating and/or measuring a reaction between a reagent and the at least one biological sample is arranged within or on the cap element.

25. Device according to claim 24 wherein the element indicates the pH value of the mixture of the liquid from the container and of the at least one biological sample.

26. Device according to claim 22, wherein the cap element comprises a window which is arranged such that a user can at least partially see the element for indicating a reaction between the reagent and the at least one biological sample.

27. Device according to claim 22, wherein the cap element comprises a window which is arranged such that a user can at least partially see the element for measuring a reaction between the reagent and the at least one biological sample.
